(19) United States
(12) Patent Application Publication
(10) Pub. No.: US 2010/0004942 A1
(43) Pub. Date: Jan. 7, 2010

(54) FRAUD DETECTION

(76) Inventors: Aristotle B. Allen, Breinigsville, PA (US); Janet Sala, Belvidere, NJ (US); Kevin Brown, Bellevue, WA (US); John Tomik, Issaquah, WA (US)

Correspondence Address: GIBSON & DERNIER L.L.P., 900 ROUTE 9 NORTH, SUITE 504, WOODBRIDGE, NJ, 07095, US

(21) Appl. No.: 12/168,217

(22) Filed: Jul. 7, 2008

(51) Int. Cl. G06Q 99/00

(52) U.S. Cl. 705/1

(57) ABSTRACT

A fraud detection methodology is disclosed wherein a map is divided into population mapping areas, and a level of normal legitimate activity for each area is calculated and stored. When activity levels indicate a possible fraud, visual indicators are displayed. The system may use a set of population mapping areas that are hierarchically arranged.

### TECHNICAL FIELD

This invention relates to fraud detection, and more specifically, to a method and apparatus for monitoring potential orders from consumers and making a determination as to whether any such potential order might be fraudulent. The invention has particular applicability in the processing of potential orders for new wireless service by a wireless network provider.

### BACKGROUND OF THE INVENTION

Fraud detection in the use of credit cards and the purchase of items on-line is a significant problem. Often by the time the fraud is discovered, the consumer, credit company, or other entity may have already lost a significant sum of money, which sum may not be recoverable from the fraudster.

Fraudulent credit card use is most often controlled by simply “black listing” the credit card number. A legitimate user who loses his credit card, or has it stolen, reports the matter, and the credit card company shuts it off. However, in the telecommunications area, another type of fraud involves a user taking improper advantage of promotions offered by various wireless companies. Specifically, such wireless companies sometimes offer partially subsidized or even free wireless devices. In exchange, the consumer is required to sign up for a use plan for a prescribed time, say two years. The wireless provider assumes it will more than make up for the device subsidy due to the use fees that consumer will incur.

Fraudsters however, can cheat the system by ordering a large number of such subsidized wireless devices, and then reselling them individually to other consumers. Many, if not the majority, of such devices are then used on networks other than that operated by the entity selling the wireless device. Hence, another network provider receives the use revenue, and the provider actually supplying the wireless device does not make its expected revenue.

In view of the above, there exists a need to be able to detect fraudsters seeking to buy plural wireless devices as part of a promotional offering and then resell them in a manner that does not permit the entity offering the promotion to recoup its investment. Moreover, the invention has applicability in any type of sales where an initial item or service is provided at a subsidized cost, under the assumption that the subsidy will be recouped via future use. For purposes of explanation herein, we use the wireless telecommunications device example, although it is understood that the present invention is not limited thereto.

### SUMMARY OF THE INVENTION

The above and other problems of the prior art are overcome in accordance with the present invention which relates to a method and apparatus for detecting potential fraudulent activity when a user is attempting to order wireless service. In one embodiment, a map of the total service area is divided into “population mapping areas”. A population mapping area is a predetermined area of the map, wherein one or more parameters have been assigned prescribed limits. In one embodiment, a population mapping area has an associated parameter representing the average number of orders for a given unit of time for new wireless service, wherein such value is calculated from empirical data. Population mapping areas may vary in size, location, shape, etc. The specified value may vary by time of day, year, specified holidays, etc.

Prior to completing any potential order, the service provider ascertains the location from which the order is originating and assigns the potential order to a selected population mapping area. If the potential order would cause one or more parameters associated with the population mapping area to be exceeded, then the system indicates that a fraud is suspected. If the parameter(s) are exceeded by too much, the system affirmatively indicates a fraud. Preferably, the generated indicators are visual indicators.

By visually displaying population mapping areas as a hierarchy, with some inside others, and by permitting a visual time lapse playback of all activity, fraud detection is visually enhanced.

### DETAILED DESCRIPTION OF THE PREFERRED EMBODIMENT

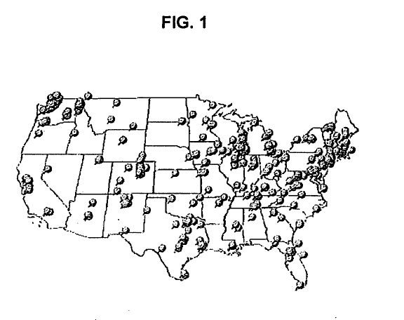

For purposes of explanation herein, we describe an exemplary embodiment of the invention wherein an order processing center for wireless service utilizes the teachings of an embodiment of the present invention. FIG. 1 shows a map of the United States, which preferably, in one embodiment of the present invention, is to be displayed on a computer monitor.

Internal to the computer is the population mapping areas. In one embodiment, each population mapping area is a zip code. In another, the map is divided into regions of equal area, and each is treated as a population mapping area. In other embodiments, the map is divided into areas of varying size and shape, based upon the service provider's ability to compile accurate data for any given area.

In a preferred embodiment, the population mapping areas are arranged as a hierarchy. Specifically, the areas of the map are divided as described above, and one or more such areas themselves are subdivided into other areas, which themselves may be subdivided. The hierarchy has a “top”, the major population mapping areas, as well as lower levels such as those described immediately prior hereto.

When an order is received, the system first assigns specific geographic coordinates to said order, such as an address, a latitude and longitude, etc. The coordinates are then determined to fall within a prescribed population mapping area. The system then ascertains a parameter of the assigned population mapping area, as if the potential order were included. For example, the system may determine that the population mapping area has had X number of orders within the past hour, even though it only averages ½ X orders per hour typically. This would exceed the prescribed threshold for the population mapping area. Other parameters may include, for example, the expected number of minutes of use originating from the population mapping area, which, when combined with data about average usage per device, would also indicate similar information as the foregoing example.

Preferably, a visual indicator is displayed on the map within the population mapping area wherein a threshold has been exceeded. In one embodiment, an overload value is also defined, and an additional visual indicator is displayed within the subject population mapping area when the threshold is exceeded by an additional amount equal to the overload value. Hence, for example, if the overload value is 30 percent, and the threshold is exceeded by nearly 100 percent, than 3 such visual indicators would be displayed within the population mapping area.

In one embodiment, the subject population mapping area may include sub-population mapping areas contained within it. In this case, the system can automatically determine, when a predetermined threshold is exceeded, which one of more of the sub population mapping areas within the population mapping area is the cause of the increased activity. Such a system would permit human intervention to permit fraud analysis and detection.

FIG. 1 depicts a map of the United States, showing by way of example that several population mapping areas each have several visual indicators. The foregoing may also be combined with “blacklisted” names or addresses to provide further detail and assistance in fraud detection. Specifically, once the visual icons indicate that a fraud is suspected, email addresses, phone numbers, or other identifying information of known fraudsters can be utilized to help determine if a particular fraudster is the culprit.

In one preferred embodiment, once a first population mapping area is determined to have too much activity, the system may scan the population mapping areas within the first population mapping area. This makes the analysis more granular to locate the actual population mapping area from where the fraud is originating. In another embodiment, once the first population mapping area from which the fraud may be originating is determined, the system can automatically provide a time lapse, replay of all of the activity within that population mapping area for the operator to review.

The order rate for any geographical area should remain relatively constant when presented as a ratio of devices ordered per unit of time divided by the population. Hence, even as the population expands, the order rates for a population mapping area should remain relatively constant.

Additionally, the system can maintain statistics on the average amount of ongoing usage for wireless devices within the population mapping area, as well as average use per device. If a number of wireless devices is ordered which would exceed an anticipated total usage, the system can conclude that some of the devices are not going to be used on the suppliers network, but are instead intended to be sold to others.

Any of the foregoing techniques can also be combined with other fraud detection techniques, even those of the prior art. The foregoing is by way of example only and is not intended to limit the claims.

1. A method comprising ascertaining a location from which an order is placed, placing information about said order into a population mapping area, and determining that a proposed order may be fraudulent if the placing of said information into said population mapping area causes said population area to exceed at least one predetermined parameter, wherein said determining includes determining that a user pattern corresponds with one wherein a user may be attempting to take advantage of an up front promotional offer without intending to properly compensate an entity offering a promotion.

2. The method of claim 1 further comprising placing visual indicators on a screen, said visual indicators indicating which population mapping areas exceed their respective predetermined parameters.

3. The method of claim 1 wherein said population mapping areas are of different sizes throughout a total area to be monitored for fraud.

4. The method of claim 3 wherein at last one of said population mapping areas includes other population mapping areas within it.

5. The method of claim 3 wherein the population mapping areas are arranged in a hierarchy, said hierarchy having a top level and at least one other level, and wherein a determination that fraud may present is made if predetermined parameters associated with a population mapping area at said top level is made, and said determination is confirmed by checking whether at least one other predetermined parameter, of at least one other level, are exceeded.

6. The method of claim 1 wherein said at least one predetermined parameter comprises a number of wireless devices ordered historically per unit of population.

7. The method of claim 2 further comprising replaying placement of visual indicators on a screen in a time lapse mode, thereby allowing an operator to visually monitor how order activity occurred during a prescribed period.

8. A method comprising compiling and storing, for a first population mapping area, a value indicative of a number of orders placed for a given unit of time, receiving an order, determining if said value is exceeded, if so, repeating said determining for a second population mapping area, said second population mapping area being within said first population mapping area.

9. The method of claim 8 further comprising comparing an email address associated with an order to an email address associated with one or more prior orders.

10. The method of claim 8 wherein said orders are orders for a mobile device or an account associated with a mobile device.

11. A method of detecting fraudulent orders comprising displaying a map divided into plural areas, generating a visual indicator in an area wherein an amount of orders for a given time exceeds a predetermined value by a predetermined amount, and generating a more granular map of any area wherein a predetermined number of visual indicators are generated.

12. The method of claim 11 further comprising obtaining a list of all orders within a prescribed time within said predetermined area.

13. A method of determining whether to permit a potential user of a wireless network to activate service, said method comprising assigning a potential order to a population mapping area, determining if the orders previously received and the potential order exceed prescribed parameters for the population mapping area, and if so, 1) automatically displaying a list of all orders within said population area and within a prescribed time limit and 2) only completing said potential order after manual intervention to review said list.

14. A method of preventing a user from taking advantage of an up front promotional supplying of a wireless device, which promotion is offered in exchange for future use, said method comprising ascertaining, for a given population mapping area, a proposed amount of future use, and a proposed number of wireless devices ordered, and displaying visual indicators if the proposed number of wireless devices is estimated to result in future use in excess of a predetermined amount associated with said population mapping area.

15. The method of claim 14 wherein said future use is future use on a particular carrier's network within a given population mapping area.
